(19) United States
(12) Patent Application Publication
(10) Pub. No.: US 2025/0172222 A1
(43) Pub. Date: May 29, 2025

(54) LINING JACKING CONSTRUCTION METHOD FOR LINEAR HYDRAULIC TUNNELS

(71) Applicant: Nanjing Hydraulic Research Institute, Nanjing (CN)

(72) Inventors: Jun LU, Nanjing (CN); Shenghua YE, Guiyang (CN); Pan MING, Nanjing (CN); Xiangqian FAN, Nanjing (CN); Guofu ZHAO, Nanjing (CN); Tao WANG, Nanjing (CN); Siyao WANG, Nanjing (CN); Jingshang WU, Nanjing (CN)

(21) Appl. No.: 18/952,041

(22) Filed: Nov. 19, 2024

(30) Foreign Application Priority Data
Nov. 23, 2023 (CN) 202311573121.0

(51) Int. Cl. F16L 1/036

(52) U.S. Cl. CPC F16L 1/036

(57) ABSTRACT

A construction method of steel pipe lining in a linear hydraulic tunnel is provided, including the following steps: S1, symmetrically installing a plurality of pumping pipes and grouting pipes from two ends of a tunnel to a middle of the tunnel respectively; S2, conveying steel pipes into the tunnel from one end of the tunnel through a traction system and a jacking system in turn, and welding all the steel pipes as a steel pipe lining of the tunnel; S3, installing a plurality of supporting structures at a certain distance inside the steel pipe lining, and installing sealing plates between the steel pipes at two ends of the tunnel and the tunnel; S4, pouring fine aggregate concrete from the middle of the tunnel to outside in turn; and S5, sequentially pouring cement slurry from the middle of the tunnel to the outside through the plurality of the grouting pipes.

### CROSS-REFERENCE TO RELATED APPLICATIONS

This application claims priority to Chinese Patent Application No. 202311573121.0, filed on Nov. 23, 2023, the contents of which are hereby incorporated by reference.

### TECHNICAL FIELD

The disclosure relates to the technical field of pipeline installation and grouting in hydraulic tunnels, and in particular to a construction method of steel pipe lining in a linear hydraulic tunnel.

### BACKGROUND

At present, there are more and more hydraulic water delivery tunnels. Under the condition of high internal water pressure, steel pipes are needed as the lining of the tunnel to meet the requirements of high head water delivery. When installing large-diameter (DN2000 and above) steel pipe lining in linear hydraulic tunnel, the usual installation and grouting methods are as follows.

1. The conventional steel pipe installation method is to transport the steel pipes into the tunnel, but for the hydraulic tunnel, the space is narrow and the construction site is limited, so it is particularly difficult to transport large-diameter steel pipes, and it is difficult to butt, adjust, align and correct the steel pipes in the tunnel, and it is difficult to weld the steel lining, so it is difficult to guarantee the welding quality.

2. Conventional concrete pouring and grouting methods need to open holes in the steel pipe wall to pour concrete and backfill with grouting to fill the gap channel between the steel pipe and the tunnel, but the opening does great damage to the water delivery steel pipe, and it is difficult to weld and repair at the later stage of the opening, so the outer wall of the opening cannot be welded.

Considering that the construction of installing large-diameter steel pipes in hydraulic tunnels has narrow space and great construction difficulty, and the existing construction method is difficult to meet the construction quality requirements, the disclosure provides a construction method of steel pipe lining in a linear hydraulic tunnel.

### SUMMARY

The objective of the disclosure is to provide a construction method of steel pipe lining in a linear hydraulic tunnel, so as to solve the problems existing in the prior art, and achieve the objectives of installing and welding water delivery steel pipes, transporting in the steel pipe tunnel, pumping concrete and cement grouting between the steel pipes and the tunnel, filling and consolidating.

In order to achieve the above objective, the disclosure provides the following scheme: the disclosure provides a construction method of steel pipe lining in a linear hydraulic tunnel, including the following steps:
S1, symmetrically installing a plurality of pumping pipes and grouting pipes from two ends of a tunnel to a middle of the tunnel respectively, and installing at a top of the tunnel, arranging output ends of the plurality of the pumping pipes and the grouting pipes outwards at intervals from the middle of the tunnel, and arranging exhaust and slurry return pipes respectively at tops of the two ends of the tunnel;
S2, conveying steel pipes into the tunnel from one end of the tunnel through a traction system and a jacking system in turn, and performing welding at tunnel entrance positions in turn, and bounding steel bars on the steel pipes synchronously until all the steel pipes enter the tunnel, and welding all the steel pipes into a whole as a steel pipe lining of the tunnel;
S3, installing a plurality of supporting structures at a certain distance inside the steel pipe lining to prevent the steel pipes from deforming, and installing sealing plates between the steel pipes at two ends of the tunnel and an inner wall of the tunnel for sealing;
S4, pouring fine aggregate concrete from the middle of the tunnel to outside in turn through the plurality of the pumping pipes until concrete is not capable of being grouted; and
S5, sequentially pouring cement slurry from the middle of the tunnel to the outside through the plurality of the grouting pipes until the slurry is discharged from the exhaust and slurry return pipes.

Optionally, in the S1:
the pumping pipes are seamless steel pipes with a diameter of 150 millimeter (mm) and a wall thickness of 6 mm, installed and fixed at the top of the tunnel;
the grouting pipes are seamless steel pipes with a diameter of 90 mm and a wall thickness of 5 mm, installed and fixed at the top of the tunnel;
the exhaust and slurry return pipes are steel pipes with a diameter of 100 mm and a wall thickness of 4 mm, installed and fixed at a top of a tunnel entrance;

Optionally, in the S2:
the steel pipes are selected with a diameter of 2000 mm, a wall thickness of 12-20 mm, and a length of 6-9 m.

Optionally, in the S2:
a first section of the steel pipes is hoisted down into a working well, transport friction parts, grouting anti-floating parts, longitudinal steel bars and circumferential steel bars are welded on a diameter-increasing ring of an outer wall of the steel pipes and the steel pipes synchronously, and then welded places of the steel pipe are subjected to anti-corrosion treatment; after installed in place, the traction system and the jacking system push the steel pipes to be transported into the tunnel.

Optionally, in the S2:
when the first section of the steel pipes is hauled and jacked into the tunnel, the traction system and the jacking system are suspended, and the jacking system is retracted; a second section of the steel pipes is hoisted into a working well, installed and welded at an end of the first section of the steel pipes, the transport friction parts, the grouting anti-floating parts, the longitudinal steel bars and the circumferential steel bars are welded on the diameter-increasing ring of the outer wall of the steel pipes and the steel pipes synchronously, so as to carry out welding line detection and the anti-corrosion treatment at the welded places; a number of sandbag counterweights are set in the steel pipes to prevent overturning; each section of the steel pipes is installed and then hauls and jacks again for conveying until all the steel pipes are hauled and jacked into the tunnel and finally jacked through the tunnel to reach another working well.

Optionally, in the S3:
the supporting structures are made of rectangular steel pipes of 150 mm*100 mm*12 mm, and several rectangular steel pipes are fixed by bolts, and a distance between the supporting structures along an axial direction of the steel pipes is 6 meters (m).

Optionally, in the S3:
the sealing plates are made of square timber and formwork to seal gaps between the steel pipes at the two ends of the tunnel and the tunnel.

Optionally, in the S4:
the pumping pipes are connected with concrete pumps in working wells at the two ends of the tunnel, and at the same time, the fine aggregate concrete is pumped into the pumping pipes; first, two pumping pipes with output ends in the middle of the tunnel are pumped, with C30 fine aggregate concrete as the concrete, and a pumping pressure is controlled at 0.3-1.0 megapascal (MPa); when the pumping pressure meets requirements and is not capable of being pumped in again, remaining pumping pipes are pumped in turn in an outward direction of the middle of the tunnel, until all the pumping pipes are completely filled, and a gap between the tunnel and the steel pipe lining is filled.

Optionally, in the S5:
grouting is carried out into the grouting pipes by grouting machines in the working wells at the two ends of the tunnel, with 0.6:1 and 0.8:1 cement slurry for the grouting, and a grouting pressure is controlled at 0.5-1.5 MPa;
first, two grouting pipes with the output ends in the middle of the tunnel are grouted; when the grouting pressure reaches requirements and is not capable of being grouted in, remaining grouting pipes are grouted in turn along the outward direction of the middle of the tunnel, until all the grouting pipes are completely grouted, the grouting pressure meets the requirements, and the exhaust and slurry return pipes return slurry.

The disclosure discloses the following technical effects.

First, the steel pipes are welded and connected outside the tunnel, and the steel pipes are transported by traction and jacking, so that the construction is convenient and the quality is guaranteed.

Second, the gap between the steel pipes and the hydraulic tunnel is filled by pouring concrete through the pumping pipe from the outside to the inside of the tunnel, and the grouting pipes are grouted with cement slurry for consolidation, so the construction is convenient, the buoyancy of pumping concrete is solved, and the continuous pouring of pumped concrete is realized.

Third, the problems of welding connection and conveying in large-diameter steel pipes are solved, and the construction efficiency of welding connection and conveying in the holes may be greatly accelerated.

Fourth, the problems of concrete pouring and grouting for steel pipe openings in straight hydraulic tunnels, such as narrow space, great construction difficulty and difficulty in repairing steel pipe openings, have been solved.

### BRIEF DESCRIPTION OF THE DRAWINGS

In order to explain the embodiments of the present disclosure or the technical solution in the prior art more clearly, the drawings needed in the embodiments will be briefly introduced below. Obviously, the drawings described below are only some embodiments of the present disclosure, and other drawings may be obtained according to these drawings without creative labor for ordinary people in the art.

FIG. 1 is a schematic view of the installation of tunnel steel pipes in the present disclosure.

FIG. 2 is a schematic structural diagram after grouting in the present disclosure.

FIG. 3 is a schematic diagram of steel pipe traction jacking conveying in the present disclosure.

FIG. 4 is a partial enlarged view at A in FIG. 3.

FIG. 5 is a schematic diagram of the first group of fine aggregate concrete pouring in the present disclosure.

FIG. 6 is a schematic diagram of the second group of fine aggregate concrete pouring in the present disclosure.

FIG. 7 is a schematic diagram of the last group of fine aggregate concrete pouring and grouting in the present disclosure.

FIG. 8 is a schematic diagram of a jacking system in the present disclosure.

FIG. 9 is a schematic diagram of a grouting machine in the present disclosure.

FIG. 10 is a schematic diagram of a concrete pump in the present disclosure.

FIG. 11 is a schematic diagram of a sealing plate in the present disclosure.

FIG. 12 is a schematic diagram of a traction system in the present disclosure.

FIG. 13 is a schematic diagram of a sandbag counter weight in the present disclosure.

### DETAILED DESCRIPTION OF THE EMBODIMENTS

In the following, the technical solution in the embodiment of the disclosure will be clearly and completely described with reference to the attached drawings. Obviously, the described embodiment is only a part of the embodiment of the disclosure, but not the whole embodiments. Based on the embodiments in the present disclosure, all other embodiments obtained by ordinary technicians in the field without creative labor belong to the scope of protection of the present disclosure.

In order to make the above objects, features and advantages of the present disclosure more obvious and easy to understand, the present disclosure will be further described in detail with the attached drawings and specific implementation methods.

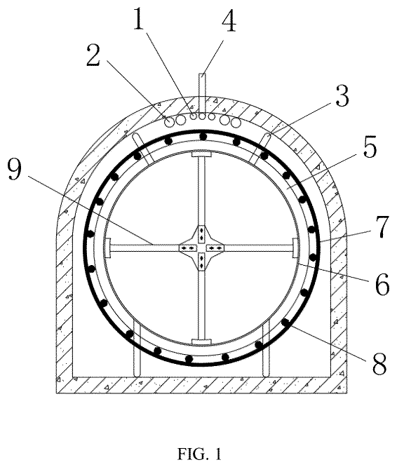

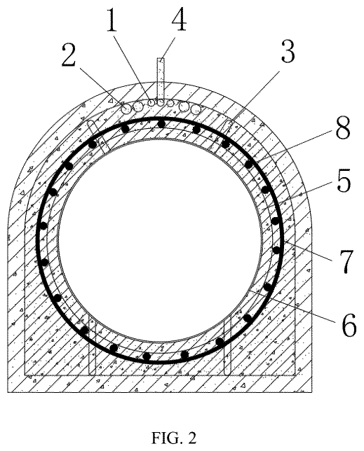

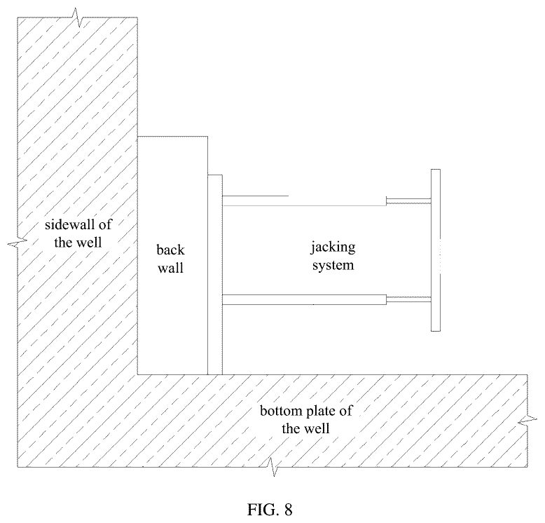

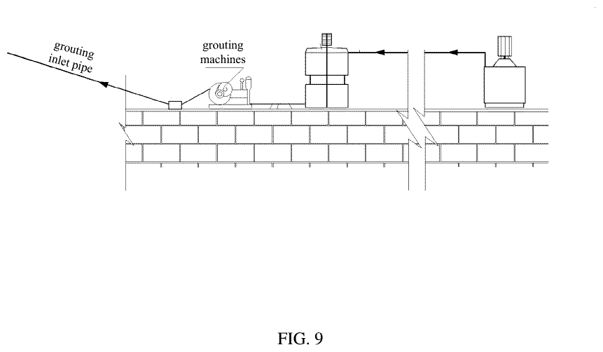

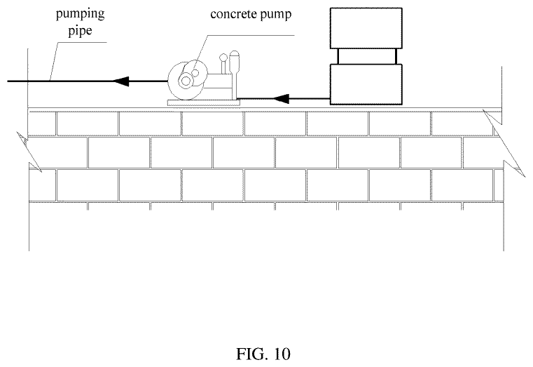

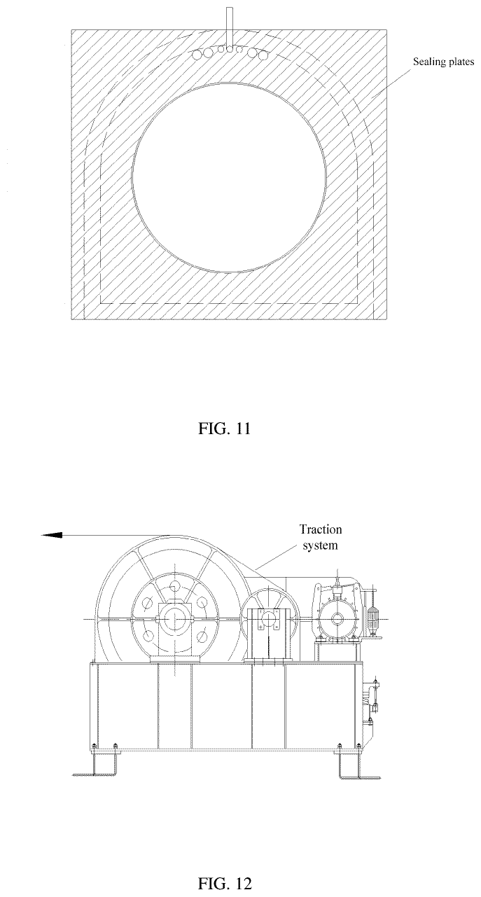

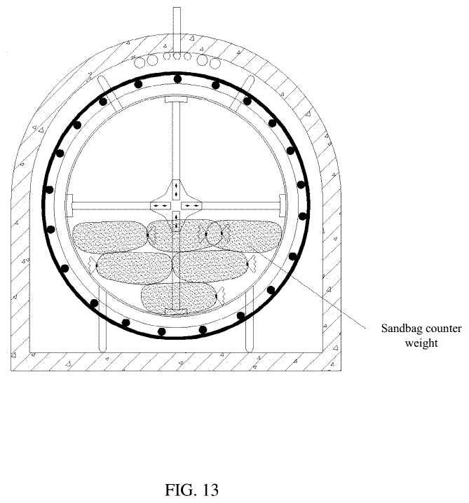

Referring to FIG. 1-FIG. 13, a construction method of steel pipe lining in a linear hydraulic tunnel includes the following steps:
S1, symmetrically installing a plurality of pumping pipes 2 and grouting pipes 1 from two ends of a tunnel to a middle of the tunnel respectively, and installing at a top of the tunnel, arranging output ends of the plurality of the pumping pipes 2 and the grouting pipes 1 outwards at intervals from the middle of the tunnel, and arranging exhaust and slurry return pipes 4 respectively at tops of the two ends of the tunnel;

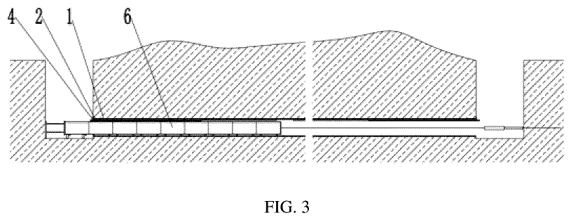

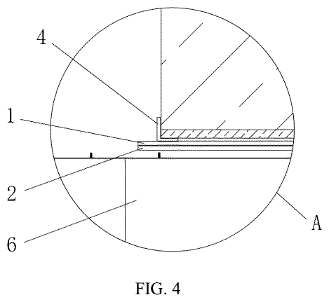

Pumping pipes 2 are used as pumping pipe 2 channels for fine aggregate concrete. According to the pumping length, seamless steel pipes with a diameter of 150 mm and a wall thickness of 6 mm are selected and installed at the top of the tunnel. The number of the installed pipes is determined according to the pumping length. Grouting pipes 1 are used as pipelines for grouting cement slurry. According to the grouting length, seamless steel pipes with a diameter of 90 mm and a wall thickness of 5 mm are selected and installed at the top of the tunnel. The number of installed pipes is determined according to the grouting length. The exhaust and slurry return pipes 4 are used as pipes for discharging the air in the tunnel during grouting and also as inspection holes for slurry return after filling. The exhaust and slurry return pipes 4 are made of steel pipes with a diameter of 100 mm and a wall thickness of 4 mm and is installed and fixed at the top of the tunnel entrance, as shown in FIG. 4.
S2, conveying steel pipes into the tunnel from one end of the tunnel through a traction system and a jacking system in turn, and performing welding at tunnel entrance positions in turn, and bounding steel bars on the steel pipes synchronously until all the steel pipes enter the tunnel, and welding all the steel pipes into a whole as a steel pipe lining 6 of the tunnel, as shown in FIG. 3.

According to the requirements of the designed water delivery scale, large-diameter steel pipes with a diameter of 2000 mm or more and a wall thickness of 12-20 mm are selected, made into water delivery steel pipes (including the diameter-increasing ring 5) in the factory, and each steel pipe is 6-9 m long, and transported to the construction site. In the first section, when the first section of the steel pipes is hoisted into the working well, it is transported to the workbench for positioning, alignment and correction. Meanwhile, the transport friction parts, the grouting anti-floating parts, the longitudinal steel bars 7 and the circumferential steel bars 8 are welded on the diameter-increasing ring 5 of the outer wall of the steel pipes and the steel pipes synchronously, and then the welded places of the steel pipe are subjected to anti-corrosion treatment. After installed in place, the traction system and the main jacking oil cylinder push the steel pipe to be transported to the tunnel. When the first section of steel pipes is jacked into the tunnel, the traction and jacking are suspended, and the hydraulic jack slowly retracts, and the other section of steel pipes is hoisted into the working well, installed and welded behind the first section of steel pipes, and connected together. The transport friction parts, the grouting anti-floating parts, the longitudinal steel bars 7 and the circumferential steel bars 8 are welded on the diameter-increasing ring 5 of the outer wall of the steel pipes and the steel pipes synchronously for safety, and welding line detection and anti-corrosion treatment are carried out, and a certain sandbag counterweight is arranged in the steel pipe to prevent overturning. Each section of the steel pipes is hauled and jacked again after installed. This process is repeated until all steel pipes are hauled and jacked into the tunnel, and finally all steel pipes are jacked through the tunnel to reach another working well, as shown in FIG. 3.
S3, installing a plurality of supporting structures 9 in the steel pipe lining 6, and installing sealing plates between the steel pipes at two ends of the tunnel and the inner wall of the tunnel for sealing.

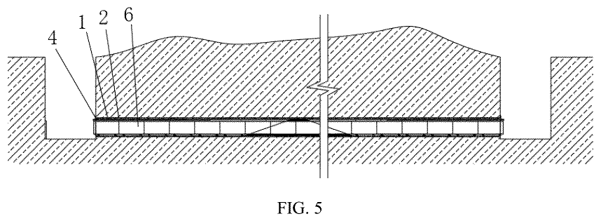

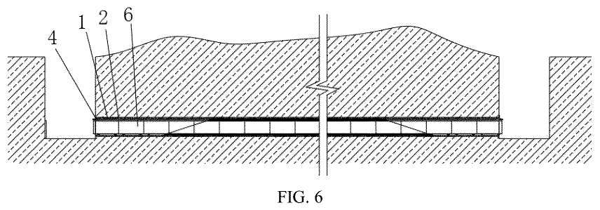

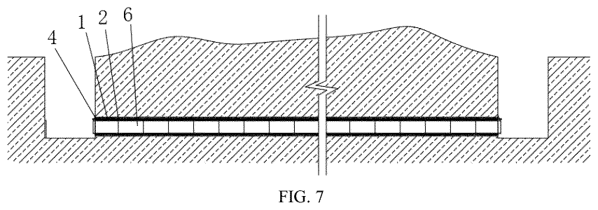

150 mm*100 mm*12 mm rectangular steel pipes are selected, with bolts in the middle, which is convenient for disassembly and may be reused. Horizontal and vertical installation is fixed inside the large-diameter steel pipe with a spacing of 6 m to prevent the steel pipes from being deformed when grouting. The sealing plate is made of square timber and formwork to seal the gap between the steel pipes at two ends of the tunnel and the tunnel to prevent slurry leakage.
S4, pouring fine aggregate concrete from the middle of the tunnel to outside in turn through the plurality of the pumping pipes 2 until concrete is not capable of being grouted, as shown in FIG. 5 and FIG. 6.
S5, sequentially pouring cement slurry from the middle of the tunnel to the outside through the plurality of the grouting pipes 1 until the slurry is discharged from the exhaust and slurry return pipes 4, as shown in FIG. 7.

The first group of pumping pipes 2 are grouted with fine aggregate concrete, and through the concrete ground pumps in the working wells at two ends of the tunnel, the pumping pipes 2 are grouted with fine aggregate concrete synchronously. First, the farthest (that is, the middle) two pipes are grouted with C30 fine aggregate concrete, and the pouring pressure is controlled at 0.3-1.0 MPa. When the first group of grouting pressure meets the requirements and may no longer be pumped in, the second group of pumping pipes 2 will be grouted with fine aggregate concrete, and the tunnel will be grouted with fine aggregate concrete through the ground pumps in the working wells at two ends of the tunnel in the same way as in the previous step. This process will be repeated until all the pumping pipes are grouted and the tunnel is filled. Grouting is carried out into the grouting pipes 1 synchronously through the grouting pump in the working wells at two ends of the tunnel. 0.6:1 and 0.8:1 cement slurry is selected for grouting, and the grouting pressure is controlled at 0.5-1.5 Mpa. First, the farthest (that is, the middle) two pipes are grouted. No more grouting may be done when the grouting pressure meets the requirements, and then the adjacent pipes are grouted in turn. This process is repeated until all the grouting pipes 1 are completely grouted, the grouting pressure meets the requirements and the slurry return pipes return slurry, which fills and consolidates the gap between the large-diameter steel pipe and the tunnel.

The jacking transport friction parts are arranged on the outer wall of the steel pipes, which prevents the steel pipes from directly rubs against the bottom plate of the tunnel in the jacking process, and ensures that the anticorrosion layer of the steel pipe is not damaged by friction. The jacking transport friction parts are made of I-beam and are steel plate, welded to the steel pipe and the diameter-increasing ring 5, and plays a supporting and sliding role.

Grouting anti-floating parts are welded on the outer wall of the steel pipe and the diameter-increasing ring 5, which are made of I-beam and arc steel plate to prevent the large-diameter steel pipe from floating during grouting.

The traction system and the jacking system are arranged in the working well, and the traction jacking method avoids the problem that the steel pipe is buckled due to excessive pressure when jacking alone. The traction system consists of traction equipment and steel wire rope, and the jacking system is a special hydraulic jack for pipe jacking, which has mature technology, high jacking control precision and small deviation, and may be jacked and corrected from time to time.

The pumping and grouting technology is to install the pumping pipes 2 and grouting pipes 1 at the top of the vault of the tunnel. In the working well, the ground pump and grouting machine are used to pour concrete and cement slurry into the tunnel, and the gap between the large-diameter steel pipe and the tunnel is continuously filled, and the concrete filling body is gradually formed, which plays the role of filling and consolidation.

The orientation or positional relationships indicated by the terms “longitudinal”, “transverse”, “upper”, “lower”, “front”, “rear”, “left”, “right”, “vertical”, “horizontal”, “top”, “bottom”, “inner”, “outer” are based on the orientation or positional relationship shown in the drawings are only for the convenience of describing the disclosure, rather than indicating or implying that the device or element referred to must have a specific orientation, be constructed and operated in a specific orientation, and therefore cannot be understood as a limitation to the disclosure.

The above-mentioned embodiments only describe the preferred mode of the disclosure, and do not limit the scope of the disclosure. Under the premise of not departing from the design spirit of the disclosure, various modifications and improvements made by ordinary technicians in the field to the technical solution of the disclosure shall fall within the protection scope determined by the claims of the disclosure.

1. A construction method of steel pipe lining in a linear hydraulic tunnel, comprising following steps:
S1, symmetrically installing a plurality of pumping pipes from two ends of a tunnel to a middle of the tunnel and symmetrically installing a plurality of grouting pipes from two ends of the tunnel to the middle of the tunnel at a top of the tunnel, arranging output ends of the plurality of the pumping pipes and the grouting pipes outwards at intervals from the middle of the tunnel, and arranging exhaust and slurry return pipes respectively at tops of the two ends of the tunnel;
S2, conveying water supply steel pipes into the tunnel from one of two ends of the tunnel through a traction system and a jacking system in turn, and performing welding at tunnel entrance positions in turn, and bounding steel bars on the steel pipes synchronously until all of the steel pipes enter the tunnel, and welding all of the steel pipes into a whole as a steel pipe lining of the tunnel;
S3, installing a plurality of supporting structures at a certain distance inside the steel pipe lining to prevent the steel pipes from deforming, and installing sealing plates between the steel pipes at the two ends of the tunnel and an inner wall of the tunnel for sealing seal gaps between the steel pipes at the two ends of the tunnel and the tunnel along a length of the tunnel;
S4, pouring fine aggregate concrete from the middle of the tunnel to outside in turn through the plurality of the pumping pipes; and
S5, sequentially pouring cement slurry from the middle of the tunnel to the outside through the plurality of the grouting pipes until the slurry is discharged from the exhaust and slurry return pipes;
wherein in step S1:
the pumping pipes are seamless steel pipes with a diameter of 150 mm and a wall thickness of 6 mm, installed and fixed at the top of the tunnel;
the grouting pipes are seamless steel pipes with a diameter of 90 mm and a wall thickness of 5 mm, installed and fixed at the top of the tunnel;
the exhaust and slurry return pipes are steel pipes with a diameter of 100 mm and a wall thickness of 4 mm, installed and fixed at a top of a tunnel entrance;
wherein in step S4:
the pumping pipes are connected with concrete pumps in working wells at the two ends of the tunnel, and meanwhile, the fine aggregate concrete is pumped into the pumping pipes; first, two of the plurality of pumping pipes with output ends in the middle of the tunnel are pumped, with C30 fine aggregate concrete as the concrete, and a pumping pressure is controlled at 0.3-1.0 MPa; when the pumping pressure is not capable of pumping fine gravel concrete, remaining pumping pipes of the plurality of pumping pipes are pumped in turn in an outward direction of the middle of the tunnel, until all the pumping pipes are completely filled, and a gap between the tunnel and the steel pipe lining is filled;
wherein in step S5:
grouting is carried out into the grouting pipes by grouting machines in the working wells at the two ends of the tunnel, with 0.6:1 and 0.8:1 the cement slurry for the grouting, and a grouting pressure is controlled at 0.5-1.5 MPa; first, two grouting pipes of the plurality of grouting pipes with the output ends in the middle of the tunnel are grouted; when the grouting pressure is not capable of grouting, remaining grouting pipes of the plurality of grouting pipes are grouted in turn along the outward direction of the middle of the tunnel, until all of the grouting pipes are completely grouted, the grouting pressure meets the requirements, and the exhaust and slurry return pipes return slurry.

2. The construction method of the steel pipe lining in the linear hydraulic tunnel according to claim 1, wherein in step S2:
the water supply steel pipes steel pipe for water conveyance are selected with a diameter of 2000 mm, a wall thickness of 12-20 mm, and a length of 6-9 m.

3. The construction method of the steel pipe lining in the linear hydraulic tunnel according to claim 2, wherein in step S2:
when a first section of the water supply steel pipes is hoisted down into one of the working wells, transport friction parts, grouting anti-floating parts, longitudinal steel bars and circumferential steel bars are welded on a diameter-increasing ring of an outer wall of the water supply steel pipes and the water supply steel pipes synchronously, and then welded places of the steel pipes are subjected to anti-corrosion treatment; after installed in place, the traction system and the jacking system push the water supply steel pipes to be transported into the tunnel.

4. The construction method of the steel pipe lining in the linear hydraulic tunnel according to claim 3, wherein in step S2:
when the first section of the water supply steel pipes is hauled and jacked into the tunnel, the traction system and the jacking system are suspended, and the jacking system is retracted; a second section of the water supply steel pipes is hoisted into the working well, installed and welded at an end of the first section of the water supply steel pipes, the transport friction parts, the grouting anti-floating parts, the longitudinal steel bars and the circumferential steel bars are welded on the diameter-increasing ring of the outer wall of the water supply steel pipes and the water supply steel pipes synchronously, and welding line detection and the anti-corrosion treatment are carried out at the welded places; a number of sandbag counterweights are set in the water supply steel pipes to prevent overturning; each section of the water supply steel pipes is installed and then hauls and jacks again for conveying until all the water supply steel pipes are hauled and jacked into the tunnel and finally jacked through the tunnel to reach another one of the working wells.

5. The construction method of the steel pipe lining in the linear hydraulic tunnel according to claim 1, wherein in step S3:
the supporting structures are made of rectangular water supply steel pipes of 150 mm*100 mm*12 mm, and several rectangular water supply steel pipes are fixed by bolts, and a distance between the supporting structures along an axial direction of the water supply steel pipes is 6 m, 150 mm, 100 mm and 12 mm present length, width, and height, respectively.

6. The construction method of the steel pipe lining in the linear hydraulic tunnel according to claim 5, wherein in step S3:
the sealing plates are made of square timber and formwork to seal gaps between the steel pipes at the two ends of the tunnel and the tunnel along the length of the tunnel.
